(19) United States
(12) Patent Application Publication
(10) Pub. No.: US 2015/0178640 A1
(43) Pub. Date: Jun. 25, 2015

(54) AUTOMATED VEHICLE PARKING MANAGEMENT SYSTEM

(71) Applicants: Jegathisvaran Balakrishnan, Thebarton (AU); Indrajit Majumder, Thebarton (AU)

(72) Inventors: Jegathisvaran Balakrishnan, Thebarton (AU); Indrajit Majumder, Thebarton (AU)

(21) Appl. No.: 14/414,707

(22) PCT Filed: Jul. 10, 2013
(86) PCT No.: PCT/AU2013/000760

§ 371 Date: Jan. 14, 2015

(30) Foreign Application Priority Data
Jul. 19, 2012 (AU) 2012903091

(51) Int. Cl. G06Q 10/00; H04N 7/18

(52) U.S. Cl. CPC G06Q 10/00; H04N 7/181; G06Q 2240/00

(57) ABSTRACT

An automated vehicle parking management system, including at least one image acquisition means configured to acquire a series of images over time of at least one parking bay having a designated parking rule; at least one sensor configured to detect presence of a vehicle parked in said at least one parking bay; a sensor module configured to derive arrival and departure triggers for the vehicle parked in the at least one parking bay from information from the at least one sensor indicative of the presence of said vehicle parked in said at least one parking bay; an image acquisition module configured to acquire a buffer of said images of the at least one parking bay upon receipt of said arrival trigger and/or said departure trigger from the sensor module for the vehicle parked in the at least one parking bay, whereby the buffer extends for an allocated series of said images acquired immediately before the arrival trigger and/or the departure trigger to a further allocated series of said images acquired immediately after the arrival trigger and/or the departure trigger, respectively; and a citation module configured to determine whether the vehicle parked in said at least one parking bay contravenes the designated parking rule based on the arrival and the departure triggers received from the sensor module, whereby a parking infringement notice can be issued to a registered owner of the vehicle based on a registration plate of the vehicle recognised from the buffer if the vehicle has been determined as contravening the designated parking rule.

### FIELD OF THE INVENTION

The present invention relates to an automated vehicle parking management system and method. The management system and method has particular, but not exclusive, application in acquiring a series of images of parking bays, each having designated parking rules, detecting the presence of a vehicle parked in any of the parking bays, acquiring a buffer of images of the parking bay upon receipt of arrival and departure triggers for a vehicle parked in any of the parking bays, and determining whether the parked vehicle contravenes any parking rules based on the arrival and the departure triggers so that a parking infringement notice can be issued to a register owner of a vehicle based on a registration plate of the vehicle recognised from the buffer.

### BACKGROUND OF THE INVENTION

Generally, vehicle parking management is performed manually by deploying parking compliance officers to traverse parking bays to issue parking infringement notices where a parked vehicle has contravened a designated parking rule for that parking bay. In this case, parking compliance officers generally rely on visual cues, such as chalked tyres or an expired parking meter, to identify whether the parked vehicle has contravened a parking rule for that parking bay. For example, a row of parking bays may have a designated time limit of two hours and, if the parking compliance officer identifies that the vehicle has overstayed the two hour time limit, the officer issues a parking infringement notice. This notice is typically issued using a handheld device that records details of the infringement on a central database and prints the notice to be affixed to the windscreen of the vehicle for the owner of the vehicle to pay. In addition, the officer may take a photograph of the infringing vehicle in the parking bay, using the same or a different device, for evidence in case the owner, or driver, of the vehicle wishes to dispute the parking infringement notice.

Parking bays, however, are frequently in high demand in many cities and, using the above manual parking management system, many parked vehicles may be contravening the parking rules for parking bays without receiving infringement notices as the likelihood of receiving an infringement notice is proportional to the amount of officers deployed in that particular area of parking spaces. That is, in this existing system, the large number of vehicles overstaying the designated parking times limits increases the demand on the available parking spaces for other drivers.

In another existing example of a vehicle parking management system, sensors are deployed for each parking bay to determine the presence of a vehicle parked in these parking bays to minimise the need for parking meters and parking compliance officers chalking tyres. In this case, the sensors, in association with, say, a central parking management server, provide information regarding the arrival and the departure times of any vehicle parked in the parking bays. The arrival and departure times can then be used to determine whether a vehicle contravenes a designated parking rule for that parking bay. If the server determines that a vehicle does, in fact, contravene the designated parking rule of that parking bay, the server sends an alert to a parking compliance officer nearby, via a portable device carried by the officer, to issue an infringement notice to that vehicle. This parking management system, however, still requires the deployment of parking compliance officers who may not get to the vehicle in time to issue an infringement notice and who add expense to the system.

### SUMMARY OF THE INVENTION

According to one aspect of the present invention, there is provided an automated vehicle parking management system, including at least one image acquisition means configured to acquire a series of images over time of at least one parking bay having a designated parking rule; at least one sensor configured to detect presence of a vehicle parked in said at least one parking bay; a sensor module configured to derive arrival and departure triggers for the vehicle parked in the at least one parking bay from information from the at least one sensor indicative of the presence of said vehicle parked in said at least one parking bay; an image acquisition module configured to acquire a buffer of said images of the at least one parking bay upon receipt of said arrival trigger and/or said departure trigger from the sensor module for the vehicle parked in the at least one parking bay, whereby the buffer extends for an allocated series of said images acquired immediately before the arrival trigger and/or the departure trigger to a further allocated series of said images acquired immediately after the arrival trigger and/or the departure trigger, respectively; and a citation module configured to determine whether the vehicle parked in said at least one parking bay contravenes the designated parking rule based on the arrival and the departure triggers received from the sensor module, whereby a parking infringement notice can be issued to a registered owner of the vehicle based on a registration plate of the vehicle recognised from the buffer if the vehicle has been determined as contravening the designated parking rule.

In an embodiment, there is a plurality of parking bays managed by the system and each parking bay has a designated parking rule. For example, the parking rule may be a designated time limit of, say, two hours or a no parking zone. Also, each parking bay has a sensor to detect the presence of a vehicle parked in that parking bay.

In an embodiment, the sensor module derives the arrival and the departure trigger by periodically scanning each of the sensors for a change in state indicating the presence of a vehicle parked in the corresponding parking bays. Furthermore, the sensor module implements a clock and derives an arrival and a departure time for the vehicle parked in the parking bays using the derived arrival and departure triggers and the clock. That is, the sensor module, for example, scans the sensors every, say, five seconds for a change in state and derives the arrival and the departure times of the vehicles parked in these parking bays within the nearest five seconds.

In another embodiment, the sensor module is further configured to record a log of the arrival and the departure times for the vehicles in the parking bays in a database in data communication with the sensor module. It will be appreciated by those persons skilled in the art that the log of the arrival and the departure times for the vehicle is recorded in association with an identifier for each parking bay so that the designated parking rule for each parking bay can be applied to determine whether a vehicle parked in that parking bay contravenes the associated designated parking rule.

For example, the designated parking rule is a designated time limit of two hours. The citation module determines whether the vehicle parked in a parking bay contravenes the two hour time limit using the arrival and the departure times recorded in the log. If so, a parking infringement notice can be issued to a registered owner of the vehicle based on a registration plate of the vehicle recognised from the buffer of images of the vehicle in the parking bay.

In another example, the designated parking rule is a no parking zone and the citation module determines whether the vehicle parked in a parking bay contravenes the designated no parking zone rule using the time of arrival and the departure times recorded in the log. That is, the citation module determines that a vehicle parked in the no parking zone contravenes the no parking zone if it is parked for more than, say, five minutes. It will be appreciated by those persons skilled in the art that the citation module applies some leeway time in determining whether a vehicle contravenes a no standing zone parking rule or exceeds a time limit rule. For example, a vehicle in a no standing zone for less than five minutes or a vehicle exceeding a designated time limit by less than five minutes will not be deemed a contravention and thus an infringement notice will not be issued to the owner of the vehicle in these cases.

In yet another example, the designated parking rule is a paid parking time limit corresponding to an amount paid for parking that vehicle in a parking bay. In this case, the system can be used with traditional parking meters that accept money for the parking of a vehicle in a parking bay. In this way, a vehicle is in contravention of a paid parking time limit once the amount paid for parking has been exhausted. As above, a leeway of five minutes may be applied before the citation module determines that a contravention has occurred and a parking infringement notice can be issued.

In a further example, the system includes a payment module configured to determine an amount to be paid for parking a vehicle in a parking bay using the arrival and the departure times recorded in the log. That is, the vehicle can be parked in a parking bay, which has a designated paid parking limit, and can be subsequently invoiced for the amount of time that the vehicle is parked in that parking bay. The registered owner of the vehicle is invoiced by recognising the registration plate of the vehicle from the buffer as described above with respect to a parking infringement notice.

It will also be appreciated by those persons skilled in the art that the amount of time a vehicle can be parked in a parking bay that has a paid parking limit has a designated upper time limit (e.g. a maximum of four hours at $1 per hour). As described, the citation module can also determine if the vehicle contravenes this designated time limit based on the arrival and the departure times in the log and a parking infringement notice can be issued as well as an invoice for the amount of time that the vehicle is parked in that parking bay.

In an embodiment, the system includes a user database including details of users (e.g. an owner of a vehicle) and their vehicles. In this embodiment, the payment module is further configured to issue the amount to be paid for parking to a user based on the details in the database. That is, the system provides the ability for users to register their personal details, and the details of their vehicle, in the database so that the users can park their vehicles and not have to pre-pay for the amount of time that they are parked in a parking bay. The personal details can include card or bank details so that the users can be debited for parking their vehicles. The users are thus invoiced for only the amount of time that they spend parked in a parking bay. It will be appreciated by those persons skilled in the art that the user database also includes details of exempt vehicles, for example ambulances or police cars, that are not invoiced for parking on the parking bays.

As described, the payment module is configured to issue the amount to be paid to the registered owner of the vehicle based on the registration plate of the vehicle recognised from the buffer. Also, the payment module is configured to receive electronic payment of the amount determined to be paid for parking the vehicle from the user card details. For example, the payment module determines from the arrival and departure times of a vehicle in a parking bay that the vehicle stayed two hours, which corresponds to a $2 amount to be debited from the corresponding user's bank account. Also, it is envisaged that the user can pay via other means such as direct debit, SMS payment, bank card, etc. In any event, the payment module processes this payment and, if payment is not received by the payment module, an indication of the contravention is sent to the citation module so that an infringement notice can be issued to the owner of the vehicle.

In an embodiment, the image acquisition module is further configured to record a First In First Out buffer of the images of the parking bays in a volatile physical memory in data communication with the image acquisition module. For example, the image acquisition means is a plurality of cameras which are configured to acquire a series of images of, say, five parking bays each over time. The image acquisition module then records these images for each of the groups of five parking bays from each camera in the First In First Out buffer in the volatile physical memory. That is, the image acquisition module records a rolling window of images having a duration of, say, two minutes from each camera.

In an embodiment, the image acquisition module is further configured to acquire the buffer of the images of the parking bays from the volatile physical memory upon receipt of the arrival and/or the departure trigger. In an example, the buffer of images of the parking bays includes images acquired both upon receipt of the arrival and the departure trigger. That is, a buffer of, say, eight seconds showing both the arrival and the departure of the vehicle in a parking bay is used for registration plate recognition. It will be appreciated by those persons skilled in the art that a buffer showing just the arrival or the departure of the vehicle is suitable in some circumstances.

The buffer extends for an allocated series of images acquired immediately before the arrival and the departure trigger to a further allocated series of images acquired immediately after the arrival trigger and the departure trigger, respectively. With reference to the above example, the allocated series of images thus include images taken by the camera extending for the period of time of two seconds before the arrival or the departure trigger and two seconds after the arrival or the departure trigger. That is, the video footage comprising the series of images shows the vehicle entering and leaving the parking bay. Particularly, it shows the vehicle from two seconds before it is parked in a parking bay to two seconds afterwards and it shows the vehicle from two seconds before it is removed from the parking bay to two seconds afterwards. In this way, the buffer can be used to recognise a registration plate of the vehicle so that a parking infringement notice can be issued to the registered owner of the vehicle as, in some circumstances, the registration plate of a vehicle may be obscured from view and thus from recognition whilst it is parked.

In an embodiment, the image acquisition module is further configured to record the buffer of the images of the parking bay showing the vehicle parked therein in a database in data communication with the image acquisition module. Again, with reference to the above example, the stored buffer includes the four seconds of footage surrounding the arrival of the vehicle and the four seconds of footage surround the departure of the vehicle. It will be appreciated by those persons skilled in the art that the arrival and departure footage may be recorded in the database separately. Nonetheless, as with the arrival and departure time logs described above, the footage is recorded with reference to an identifier for that parking bay or the camera. In one embodiment, these buffers are recorded in association with the log of arrival times and departure times of each vehicle in the parking bays, and, in a further embodiment, in association with camera identifier.

In an embodiment, the system further includes a registration plate recognition module configured to electronically recognise the registration plate of the vehicle from the buffer recorded in the database. The registration plate recognition module recognises the registration plate, in one example, by scanning predefined areas in the series of images of the parking bays for the registration plate of the vehicle, where the predefined areas correspond to a likely area of the image where the registration plate of the vehicle is to be located. That is, the registration plate recognition module electronically recognises the registration plate of a vehicle parked in a parking bay by analysing the recorded four seconds of arrival footage and four seconds of departure footage of the vehicle in the parking bay. Once a number is recognised and determined, it can be used to issue an infringement notice to the registered owner of the vehicle or it can be issued to issue an invoice for an amount to be paid for parking in a parking bay as described above.

In accordance with another aspect of the invention, there is provided an automated vehicle parking management method, including: acquiring a series of images over time of at least one parking bay having a designated parking rule using at least one image acquisition means; detecting presence of a vehicle parked in said at least one parking bay using at least one sensor; deriving arrival and departure triggers for the vehicle parked in the at least one parking bay from information from the at least one sensor indicative of the presence of said vehicle parked in said at least one parking bay; acquiring a buffer of said images of the at least one parking bay upon receipt of said arrival trigger and/or said departure trigger for the vehicle parked in the at least one parking bay, whereby the buffer extends for an allocated series of said images acquired immediately before the arrival trigger and/or the departure trigger to a further allocated series of said images acquired immediately after the arrival trigger and/or the departure trigger, respectively; and determining whether the vehicle parked in said at least one parking bay contravenes the designated parking rule for that parking bay based on the arrival and the departure triggers, whereby a parking infringement notice can be issued to a registered owner of the vehicle based on a registration plate of the vehicle recognised from the buffer if the vehicle parked in the at least one parking bay has been determined as contravening the designated parking rule.

In accordance with another aspect of the invention there is provided an automated vehicle parking management server, including a sensor module configured to derive arrival and departure triggers for a vehicle parked in at least one parking bay having a designated parking rule from information from at least one sensor configured to detect presence of said vehicle parked in said at least one parking bay; an image acquisition module configured to acquire a buffer of images from at least one image acquisition means configured to acquire a series of images over time of the at least one parking bay upon receipt of said arrival trigger and/or said departure trigger from the sensor module, whereby the buffer extends for an allocated series of said images acquired immediately before the arrival trigger and/or the departure trigger to a further allocated series of said images acquired immediately after the arrival trigger and/or the departure trigger, respectively; and a citation module configured to determine whether the vehicle parked in said at least one parking bay contravenes the designated parking rule based on the arrival and the departure triggers received from the sensor module, whereby a parking infringement notice can be issued to a registered owner of the vehicle based on a registration plate of the vehicle recognised from the buffer if the vehicle has been determined as contravening the designated parking rule.

In accordance with another aspect of the present invention, there is provided a computer program code which, when executed, implements the above method.

In accordance with another aspect of the present invention, there is provided a computer readable medium comprising the above program code.

In accordance with aspect embodiment of the present invention there is provided a data signal comprising the above program code.

### BRIEF DESCRIPTION OF THE DRAWINGS

In order that the invention can be more clearly ascertained, examples of embodiments will now be described with reference to the accompanying drawings, wherein:

FIG. 1 is a schematic view of an automated vehicle parking management system according to an embodiment of the present invention.

FIG. 2 is a flowchart of an automated vehicle parking management method according to an embodiment of the present invention.

FIG. 3 is a further schematic view of the system of FIG. 1.

FIG. 4 is a schematic view of a buffer of images of a parking bay according to an embodiment of the present invention.

FIG. 5 is a further flowchart of the method of FIG. 2.

FIG. 6 is a log of arrival and departure times for a vehicle in a parking bay according to an embodiment of the present invention.

FIG. 7 is a log of payment received for an amount of time that a vehicle is parked in a parking bay according to an embodiment of the present invention.

FIG. 8 is a schematic view of system architecture for paid parking according to an embodiment of the present invention

FIG. 9 is a further flowchart of an automated vehicle management method according to an embodiment of the invention.

FIG. 10 is a further flowchart of the method of FIG. 9.

FIGS. 11A and 11B are a further flowchart of the method of FIG. 9.

### DETAILED DESCRIPTION

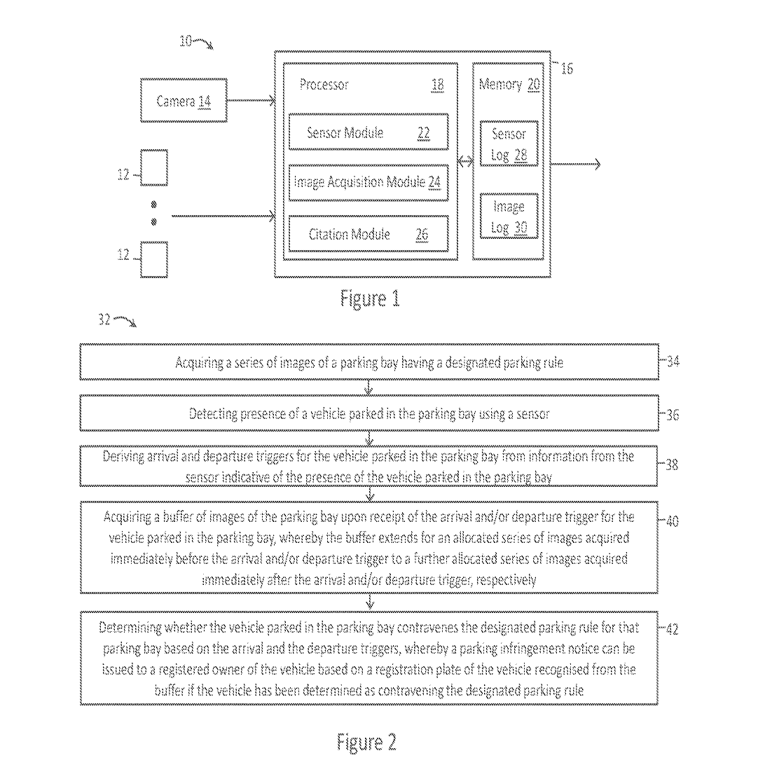

According to an embodiment of the present invention, there is provided an automated vehicle parking management system 10, as shown in FIG. 1. The system 10 includes at least one image acquisition means 14 configured to acquire a series of images over time of at least one parking bay having a designated parking rule. In the embodiment, the image acquisition means 14 is a camera capable of taking video footage of a number of parking bays. It is envisaged that the system 10 has a number of such cameras 14 to cover each of the parking bay being managed by the system 10. The system also includes at least one sensor 12 configured to detect presence of a vehicle parked in the at least one parking bay. In the embodiment, one sensor 12 is provided for each parking bay. For example, each of the sensors 12 is buried under the surface of the parking bays. It will be envisaged, however, that, in some cases, one sensor, could sense more than one parking bay. Nonetheless, in the example described below, there is multiple parking bays, each having one sensor 12 disposed therein, and images of these bays are acquired using the camera 14.

In the embodiment, the camera 14 and the sensors 12 are in data communication with a server 16 configured to implement the parking management system 10. In an embodiment, the server 16 is remote from the camera 14 and the sensors 12 and in wireless communication therewith.

The server 16 includes a processor 18 configured to implement a number of modules and a memory 20. The processor 18 includes a sensor module 22 configured to derive arrival and departure triggers for vehicles parked in the parking bays from information from the sensors 12 indicative of the presence of vehicles parked in the parking bays. The server 16 also includes an image acquisition module 24 configured to acquire a buffer of images of the parking bays upon receipt of the arrival trigger and/or the departure trigger from the sensor module 22 for each vehicle that is parked in the parking bays. The buffer extends for an allocated series of images acquired immediately before the arrival trigger and/or the departure trigger to a further allocated series of images acquired immediately after the arrival trigger and/or the departure trigger, respectively. That is, as described above, the allocated series of images includes images taken by the camera 14 extending for the period of time of, say, two seconds before the arrival or the departure trigger and two seconds after the arrival or the departure trigger. The respective four seconds of footage shows the vehicle entering and leaving the parking bay.

The server 16 further includes a citation module 26 configured to determine whether a vehicle parked in one of the parking bays contravenes its designated parking rule based on the arrival and the departure triggers received from the sensor module 22. In this way, a parking infringement notice can be issued to a registered owner of the vehicle based on a registration plate of the vehicle recognised from the buffer if the vehicle has been determined as contravening the designated parking rule. As described above, the registration plate recognition can be performed automatically, through use of a registration plate recognition module. In any event, an indication of the parking infringement notice to be issued to a registered owner is outputted from the server 16.

As described, the sensor module 22 derives the arrival and the departure trigger by periodically scanning each of the sensors for a change in state indicating the presence of a vehicle parked in one of the corresponding parking bays. Also, the sensor module 22 implements a clock and thus derives an arrival and a departure time for vehicles parked in the parking bays. These arrival and departure for the parked vehicles are stored in a sensor log 28 database in the memory 20. Also, the image acquisition module 24 is configured to record the buffer of images of the parking bay showing a parked vehicle, as well as it arriving and the departing the parking bay, in an image log 30 in the memory 20. The image buffers and the arrival and departure time logs are stored with reference to an identifier of that parking bay in the respective logs in the memory 20 so that this information can be used for subsequent analysis by, say, the number plate recognition module and the citation module 26.

It will be appreciated by those persons skilled in the art that the memory 20 can be hosted by one or more further servers in data communication with the server 16. For example, the sensor log 28 is implemented by one server and the image log 30 is implemented by another server, both servers being in data communication, via wired or wireless communication, with the server 16 and the modules for implementing the parking management system 10 residing thereon.

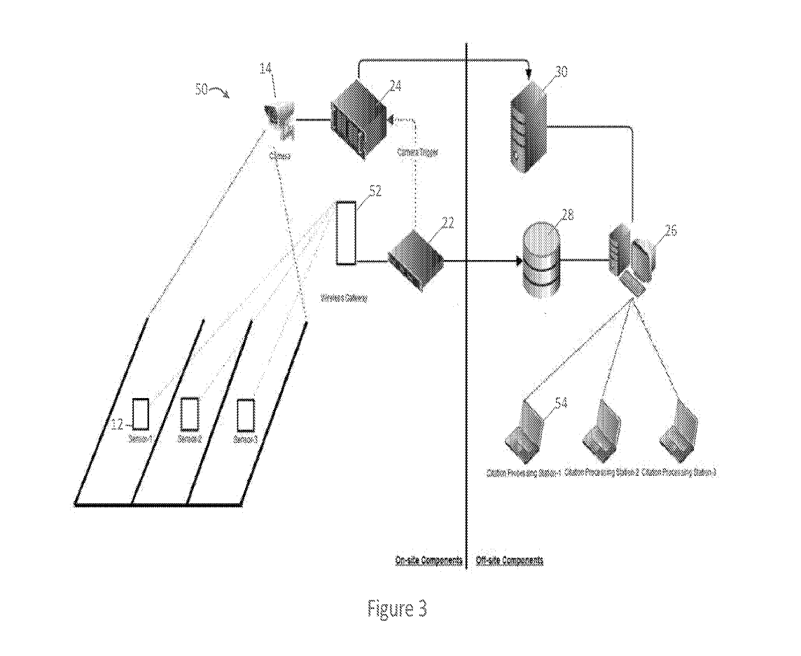

In the embodiment shown in FIG. 3, a distributed automated vehicle parking management system 50 includes the components of the above described system 10. Shown here are three sensors 12 located with respect to three parking bays. As described, the sensors 12 are buried underneath the surface of the parking bays and use a magnetic field sensor to sense presence of a vehicle parked in the corresponding parking bay. It is envisaged that the sensor can use some other detectable property, such as weight, to sense presence of a vehicle. Also, the sensors 12 need not be buried under the surface of the parking bay. For example, the sensors 12 could be in the form of a pressure sensitive plate located on top of the surface of each parking bay. In any event, the sensors 12 communicate wirelessly to a wireless gateway 52, which relays information from the sensors 12 to the sensor module 22. In this embodiment, the sensor module 22 is implemented by a control computer. As described, the sensor module 22 derives a log of arrival and departure times from information from the sensors 12 for vehicles parked in the three car parks and this log is stored in the sensor log 28 in a suitable database.

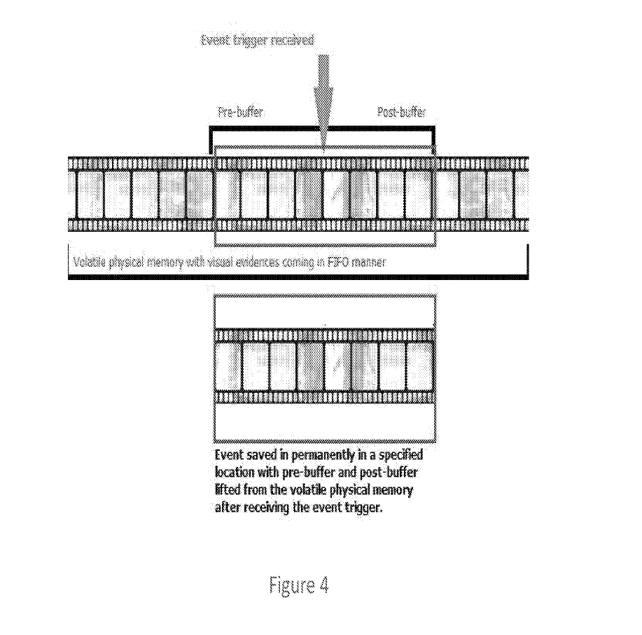

The system 50 also includes a camera 14, of the type described above, which acquires a series of images of the three parking bays over time. The images are transmitted to the image acquisition module 24, implemented by a further control computer, which records a First In First Out buffer of the images of the three parking bays in a volatile physical memory. The acquisition module 24 then acquires the buffer of the images of a parking bay from the volatile physical memory upon receipt of the arrival and the departure triggers from the sensor module 22 and records the buffers, showing the vehicle parked in the parking bays, in the image log 30 stored in another suitable database. FIG. 4 shows the buffer of images in detail. Here, it can be seen that an event trigger in the form of an arrival or a departure trigger is received and a pre and post buffer extending immediately before and after the event trigger is acquired and recorded from the FIFO buffer in the volatile memory.

The system 50 also includes a computer implementing the citation module 26, which receives arrival and departure times from the sensor log 28 for the parking bays and compares it with designated parking rules (e.g. a designated time limit) for the parking bays. If the citation module 26 determines that a vehicle parking in a parking bay has exceeding a designated time limit, it will receive a buffer of images of that parking bay showing the vehicle arriving and leaving the parking bay from the image log 30. In this embodiment, the buffer is then transmitted to a citation processing station 54 for an operator to recognise a registration plate of the vehicle so that the registered owner of the vehicle can be issued a corresponding parking infringement notice, such as a fine.

It can be seen from FIG. 2 that the system 50 is an automated parking enforcement tool for on-street parking. It enables a parking resource provider to monitor their parking resources remotely with the minimum need of on-site personnel. Any non-compliance of regulations is detected remotely and infringements are thus issued off-site. It can be seen that the image acquisition module 24, the gateway 52 and the sensor module 22 are implemented on-site; that is, somewhat adjacent the parking bays. The data storage and the citation module 26 are, on the other hand, implemented off-site; that is, somewhat away from the parking bays.

The sensor module 22 is herein referred to as a SMART eSense module. The main objective of this module is to detect the presence of a vehicle on a particular parking bay and log its activity accordingly, as described. The sensor module 22 is implemented by an on-site computer, communicates with Electro-magnetic wireless sensors 12 and/or the wireless gateway 52. The image acquisition module 24 is herein referred to as a SMART eWatch module as is also implemented by the same or a different on-site computer.

The sensors 12 are designed to detect any change of surrounding electro-magnetic field occurred by a presence of a vehicle. It will be appreciated by those persons skilled in the art that, to avoid excessive installation costs, wireless sensors are used instead of the conventional electro-magnetic loops or other wired sensors. Each sensor 12 is buried under each bay at the central point of every bay. In an example, the sensors 12 are buried 2 inches under the bitumen surface of the ground for an effective sensing of the vehicle with minimum interference. The sensors 12 include a battery with an expected lifetime of 5-10 years, which obviously varies with sampling rate, battery type, etc.

The sensors 12 communicate with the on-site control computer, hosting the sensor module 22, which is placed in a secured enclosure and is connected to the gateway 52. It is envisaged that more than one gateway 52 is used for a plurality of parking bays and each gateway is designed to communicate with a number of sensors 12 through Time Division Multiplexing (TDM). Thus, whenever a vehicle pulls into a particular parking bay, the sensor 12 is activated and sends an arrival, or check-in, trigger to the control computer. Again when that particular vehicle leaves the parking bay, the sensor goes back to reset mode and sends a departure, or check-out, trigger to the control computer. This process is repeated throughout the day and, at the end of the day, a usage log for that particular bay is generated. The software running in the control computer is not only designed to receive the triggers from different sensors and record the event time but also to generate additional instantaneous triggers for every check-in and check-out event which is then passed on to the image acquisition module 24 to record the event of the vehicle arriving and departing the parking bay.

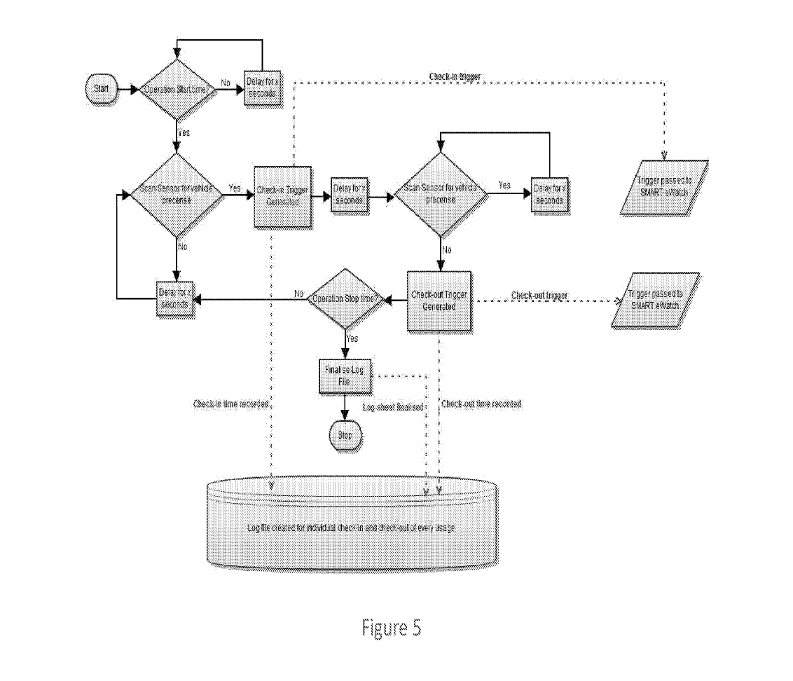

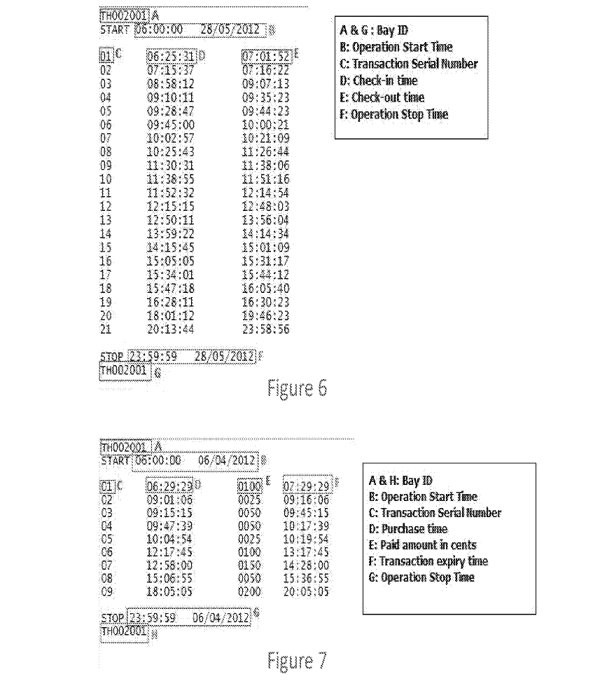

FIG. 5 show a flow chart describing the operation of the software in the on-site computer, implementing both the eWatch and eSense modules, to create image and sensor logs (as shown in FIG. 6) for every parking bay. Here, it can be seen the on-site control computer, implementing both the eWatch and eSense modules, creates and finalises individual log-sheets for every bay under its service area after say the monitoring operation ceases every night. In one example, all the log files are then transmitted through an in-built 3G modem to a pre-configured email address to be stored on a database. An example of a typical log sheet for a particular bay is shown in FIG. 6.

Referring back to FIG. 3; in an example, each wireless gateway 52 can accommodate up to 48 sensors (e.g. nodes). The sensors 12 have a transmission range of 2 km line-of-sight, provided a clear line-of-sight is available. This range gets decreased if no line-of-sight is available. In case of no line-of-sight is achieved on-site, the loss of transmission can be compensated by, for example, deploying repeaters in between the sensors and the gateway 52. In the embodiment shown in FIG. 3, the wireless gateway 52 is attached to the control computer implementing the sensor module 22 through USB 2.0 ports. For optimum performance, provisions are made to connect up to four gateways to each control computer. The design and the expectation of the on-site control computer is made taking in account that it will be working in an uncontrolled environment. It is thus expected to connect to the sensors 12 through the wireless gateway 52 and to identify each and every sensor 12 individually by assigning a unique identifier to each and every sensor 12. Furthermore, it is to send periodic pings to each and every sensor 12, apply TDM, and receive replies of the ping request sent to the sensors 12 and tabulate any change of situation.

The control computer implementing the sensor module 22 is also configured to generate the arrival and departure triggers (e.g. the camera triggers) for every change of state trigger received from any of the sensors 12. It also is configured to maintain an individual record for every individual identity as described and to start and stop operation at a specified time of the day. Furthermore, it is configured to write the sensor logs into individual files and save it locally, or remotely, in the sensor log 28. It also can email these log files to a specified location through, say, GPRS, after finalising the log file so that the citation module 26 can determine whether to issue a parking infringement notice.

The control computer implementing the sensor module 22 is further configured to generate a “memory overload” alarm when say 75% of the local memory is full and then immediately finalise the batch file to email these to the specified location. Also, it can be configured to generate alarms for different events like “link failure” when no ping replies are received from a particular sensor is repeatedly say 3 to 4 times and to generate an “unauthorised access” alarm and a vandalism alarm in case of any mishandling, vandalism, etc. In addition, the control computer is able to allow remote access through GPRS-GSM to the stored logs, allow remote access through GPRS-GSM for system configuration and allow remote access through GPRS-GSM for system restoration.

As described, the image acquisition module 24, herein referred to as the SMART eWatch module, is responsible for capturing visual evidence for any activity sensed by the SMART eSense module. The camera 14 is an IP camera, and more than one of these cameras are deployed with on-site data stations to support their operation. The camera control software is configured to receive arrival and departure events triggers, of the type described above, which are sent by the SMART eSense control-computer so that the eWatch module can start recording the buffer of images of the particular parking bay. In one embodiment, the volatile memory described above is located locally with respect to each camera and the SMART eWatch control software sends a trigger to the appropriate camera in the network to acquire the buffer of images when an arrival or a departure trigger is received. As shown in FIG. 3, one camera 14 covers there parking bays, hence any trigger from the three displayed sensors 12 is passed on to the one camera 14 only.

The main purpose of the eWatch module is to capture visual evidence of any event (e.g. check-in or check-out) where a recognisable/readable registration plate of a vehicle is involved. It has been noticed that in several cases, registration plates of vehicles are not clearly visible during the event or after the event, whereas they are clearly visible a few seconds before the event takes place. For that purpose, pre-buffered recording is introduced in this module. As described, the camera 14 normally records continuously in a volatile physical memory, which gets over-written in a FIFO manner. When a trigger is received from the SMART eSense module, the camera control software starts recording images starting from, say, a few seconds before the event till a few seconds after the event has occurred. This enables clear viewing of the vehicles—and their registration plates—moving in or moving out of a parking bay from the images.

Automatic Registration Plate Recognition can be implemented when a trigger is received from the sensor module 22. In one embodiment, to implement automatic registration plate recognition, the camera software scans pre-defined areas in the images for registration plates for each parking bay. That is, when a trigger is received from the sensor module 22, a registration plate recognition module (not shown) scans only in a pre-defined scan area of the buffer for a particular bay for registration plates. The number plate recognition module can be implemented on-site (e.g. at the camera 14 somewhat adjacent the parking bays) or implemented off-site (e.g. at the processor 18 somewhat away from the parking bays). The pre-defined area corresponds to where it is likely for the vehicle's registration plate to be found in the images and the registration plate recognition module looks for landmarks, such as the white background colour of the plate, in that area to then determine the registration plate details. It will be appreciated by those persons skilled in the art that the registration plate recognition module is also configured to pass a particular image on to manual processing if no registration plate details can be recognised or say when more than one registration plate is recognised in the same scan area.

In the embodiment shown in FIG. 3, the citation module 26 for determining whether a parked vehicle contravenes a designated parking rule using the sensor log 28 of arrival and departure times for each parking bay is implemented by an off-site server. The citation module 26, herein referred to as a SMART eCite module, is responsible for analysing the data acquired from the SMART eSense module as well as obtaining the visual evidence from the image log 30. The SMART eCite module is, in one example, web-based software which requires no additional software installation in any individual PC. The main software is to be installed in a host PC or server (as shown in FIG. 3) and then it can be accessed from any PC in the network using a compatible browser. For instance, the eCite software supports IE 9.0 and Mozilla Firefox.

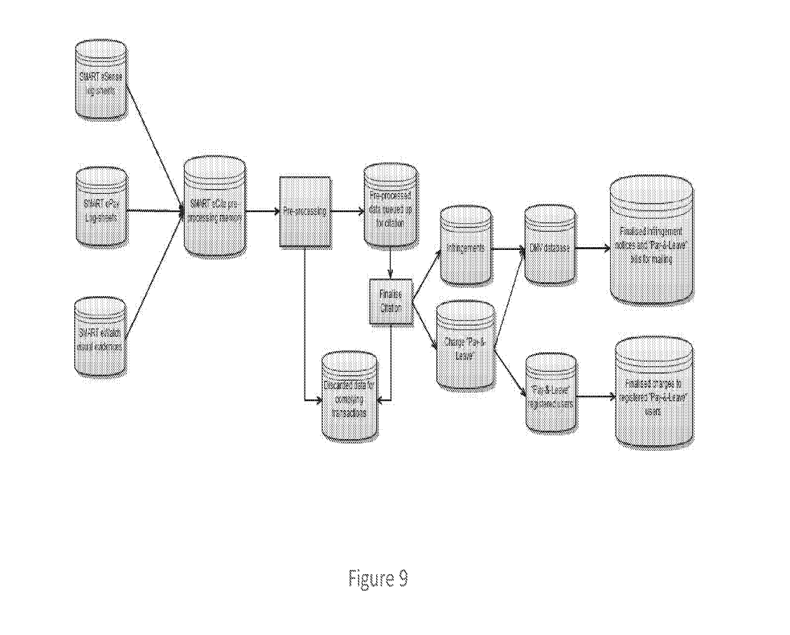

The SMART eCite module is thus implemented in a client-server arrangement, which has the following advantages. It has the flexibility of creating different access levels for different users, the flexibility of having a varied range of reporting capabilities, such as area performance report, user performance report, financial reports, etc. The module has the flexibility of creating new restrictions, new service areas, new users and new access control levels, the flexibility of generating reports in various formats which can be easily exported to existing financial software for easy accounting, the flexibility of creating temporary/permanent permits/parking exemptions, the flexibility of creating one single bay with multiple restrictions for multiple time frames, and the flexibility of cloning a created bay and reducing efforts of creating similar bays individually. Moreover, the arrangement enables a user friendly dashboard for front office/enquiry handling operation and intelligent calendar management options to introduce public holidays options for separate parking rules. A flow chart showing the flow of information with respect to the eCite module is shown in FIG. 9.

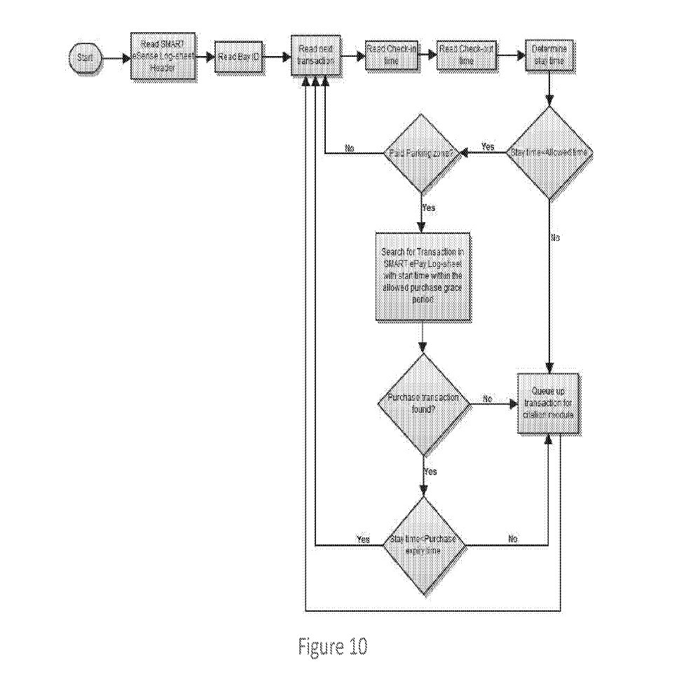

In one example, the analysis of the data acquired from the on-site components and the image and sensor logs is done in two separate operational phases: pre-processing and citation. FIG. 10 shows a flow chart of the pre-processing operation phase of the eCite module. During pre-processing, the log sheets are run through and the software checks each and every transaction on the log sheet for any possible restriction contravention of the designated parking rules for that parking bay. The transactions appearing to contravene the parking restrictions for that particular bay for a particular time-frame are queued up for transmission to the next operational phase.

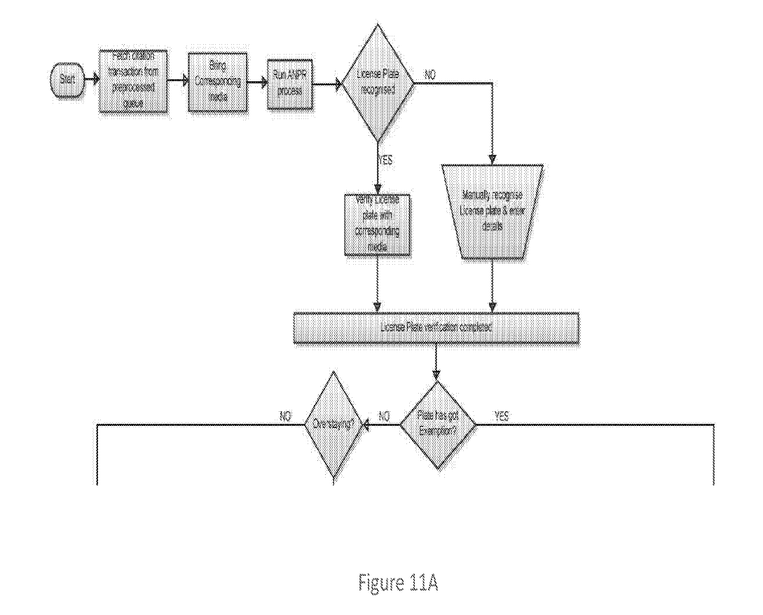

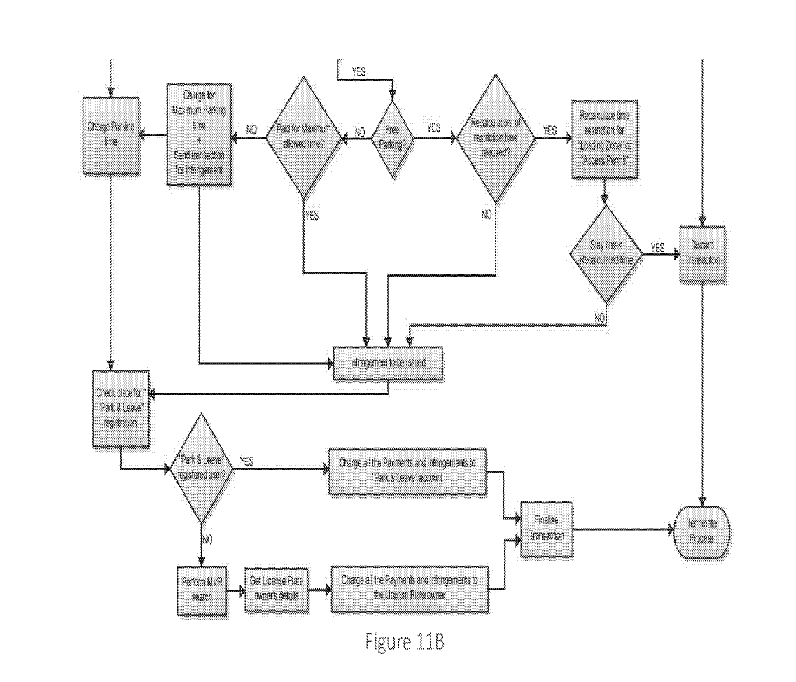

FIGS. 11A and 11B shows a flow chart of the citation phase. In this embodiment, the transactions queued up by the pre-processing operation are accessed individually to verify whether parking infringement has occurred. In addition, when a particular transaction is brought up in this phase, the software also brings up the visual evidence of the check-in and check-out event for that transaction. Here, the operator of the citation processing stations 54 of FIG. 3 recognise and determine the registration plate number of the allegedly infringing vehicle and input it in for further checking. The software then checks the registration plate number for any possible stored exemptions or permits. It will be appreciated by those persons skilled in the art that a database of allocated exemptions, such as police vehicle registration plates, is maintained and is in data communication with the eCite module.

In the example, if no permit or exemption is found for that particular registration plate number, a citation/parking infringement is issued. In this process, flexibility is given to the operator to manually override a decision and discard a particular transaction if any abnormality is observed. Also, scope for recalculating the parking restriction for a particular transaction based on access permit or commercial vehicle permit in say a loading zone is also available in the software to minimise complexity and infringement contesting after issuing a fine. Furthermore, during this citation phase, details of the citation are saved with reference to the particular citations so that they can be produced later in case the parking infringement is contested. This minimises the effort of searching for visual evidence for a particular transaction upon demand.

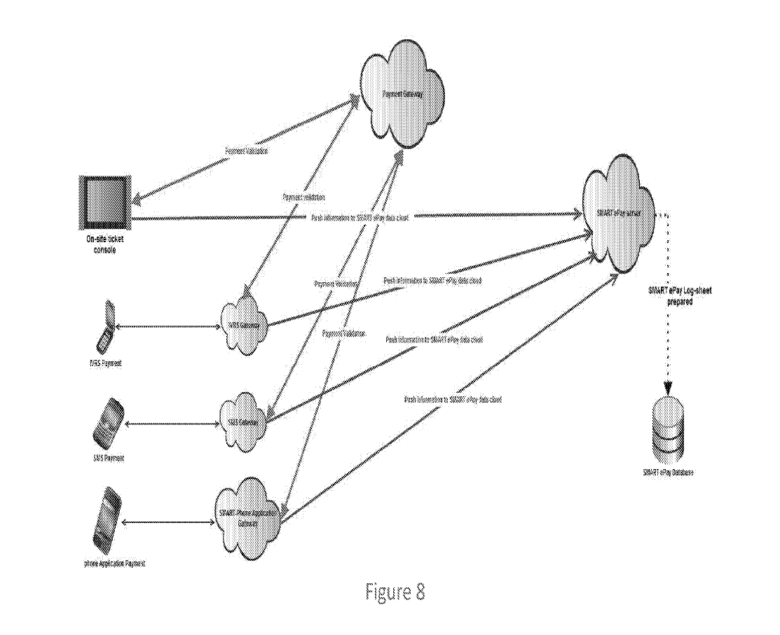

In another embodiment, the system 50 also includes a payment module, herein referred to SMART ePay. This module is responsible for handling payments in a paid parking area. Unlike the free time limit parking zones, the paid parking zones have different parking time limits based on individual ticket purchases. In this embodiment, a user uses the ePay module instead of purchasing parking time in the usual fashion, such as purchasing pay and display tickets from a ticket console or purchasing parking times in parking meters. In this case, the user inputs the particular parking bay using the ePay module that the vehicle is parked in and subsequently purchases parking time. Thus, no pay-and-display tickets are required and similar to SMART eSense module a payment/purchase log-sheet is generated and stored, as shown in FIG. 7, at the end of the day for each and every bay. Smart ePay is expected to accept payments from users where the user specifies the bay number where the vehicle is parked. The parking bay number/bay id will typically be marked on the kerbside or in a clearly visible place. Once SMART ePay finalises a transaction, it also sends the data to an information cloud where the payment log, of the type shown in FIG. 7, is created for each and every bay.

As described, the payment module is configured to accept payment from users in various forms for their desired parking and to inform the user of the expiry time of their purchased parking time. Examples of the different ways of initiating a transaction are using a ticket console, a smart phone app., SMS, and an IVRS call. The different gateways of payment are shown in FIG. 10. When a user puts through a payment through one of these payment channels, a payment validation is received. Once the payment is validated, the payment information is pushed through to the SMART ePay server with the relevant information (e.g. Bay ID, purchase time and paid amount). The SMART ePay server then calculates the expiry time of the particular transaction and creates the individual payment log sheet as described before.

In addition, the payment module is configured to determine an amount to be paid for parking a vehicle in a parking bay using the arrival and the departure times recorded in the log. In this case, the user parks their vehicle and leaves without processing any payment through any of the above payment channels in the paid parking zone. The parking activity is picked up by the SMART eSense and SMART eWatch module and passed on to the SMART eCite module to charge the specific user. In the SMART eCite module, the user is detected as parking his vehicle within the maximum allowed parking time as per the displayed signage and the user is charged accordingly. The charging can be done either through a pre-registered “Park-&-Leave” account or by fetching the registered owner's details by recognising the vehicle's registration plate from the buffer as described above. Furthermore, if a stay of more than the maximum allowed parking time is detected by the citation module for a particular vehicle, the allowed parking time is charged as “Park-&-Leave” usage charge plus an infringement amount is to be calculated and added to the invoice for the overstaying.

In an example, the system 50 is to be deployed in free, time limit parking areas. The system 50 thus only checks whether a vehicle observes the designated parking restriction time displayed in that particular area. A contravention, or violation, of the designated parking restriction (i.e. overstaying) is detected in this phase and citations/infringement notices are issued off-site without the need of on-site manual operators (e.g. parking inspectors).

In another example, the system 50 is deployed into ticket parking/paid parking areas with a little modification of the currently installed pay-and-display ticket vending machines. Here, a SMART ePay sub module is deployed through on-site payment consoles. In this example, the SMART eCite is also upgraded with added feature to compare the log-sheets acquired from SMART eSense and the SMART ePay modules so that detection of overstay exceeding the paid parking time is determined for issuance of a parking infringement notice.

In another example, other methods of payment are introduced using the SMART ePay module, such as via smartphone applications, IVRS, SMS. For example, a user parks his vehicle and notes down the bay ID from the kerbside. He then walks to the ticket console and initiates the transaction and keys in the bay ID in the ticket console. The user then selects a mode of payment. In the case where the user is unregistered, the user can make a cash payment at the ticket machine using a conventional coin-drop payment or a credit card payment (e.g. the user swipes the credit card for authorisation) or a pre-loaded cash card payment. The user then selects a time limit or a dollar amount and confirms the transaction. The transaction is processed and the specific information (e.g. payment time, bay ID, paid amount) is transmitted to the data cloud (subject to approval of the payment) for later analysis by the citation module. A payment summary with an expiry time of the transaction is also displayed to the user.

In another example, the payment management is handled by a smartphone app. In this example, the user parks his vehicle and notes down the bay id from the kerbside. The user then opens up the application in his smartphone and initiates the transaction. The smartphone will bring up the bay IDs in say a 100 metre vicinity from an in-built GPS (subject to availability) from which the user can select the specific bay or the user manually keys in the specific bay ID. The user selects a mode of payment and, for registered users, logs in with a registration ID and password. For unregistered users, the smart phone app can process credit card payments (e.g. the user keys in the C/Card number, CVV number, expiry date) or pre-loaded cash card payments. The user selects either a time limit or a dollar amount and confirms the transaction. The transaction is processed and the specific information (e.g. payment time, bay ID, paid amount) is also transmitted to the data cloud (subject to approval of the payment) and a payment summary with expiry time of the transaction is displayed to the user. The app will also generate a reminder few minutes before the expiry time and if parking limit of that specific zone allows for an extension, the user can purchase an extension through the app as well.

In yet another example, a user parks his vehicle and notes down the bay id from the kerbside. The user sends an SMS in the specific format to complete the transaction. The different formats of the text message are for different modes of payments. For example, for registered users, a text format is as follows: BAYID[space]AMOUNT(in cents value)[space]USER ID[space]PIN. For unregistered users, the user inputs the following format for Credit card or pre-loaded cash card payment: BAYID[space]AMOUNT(in cents value)[space]C/C NUMBER[space]CVV NUMBER. Alternatively, for mobile account charging, the user inputs the format: BAYID[space]AMOUNT(in cents value). The transaction is then processed and the specific information (e.g. payment time, bay ID, paid amount) is transmitted to the data cloud (subject to approval of the payment) and a payment summary with expiry time of the transaction is being sent back to the user as a reply SMS. Again, a reminder SMS is sent to the user again a few minutes before his parking time expires. If the parking limit of that specific zone allows for an extension, the user can purchase an extension of parking time by sending another SMS as a reply by just specifying the extension time. The payment will also be put through as the last mode of payment used and another payment summary with expiry time of the transaction will be sent back to the user as a reply SMS.

In another example, an IVRS (Interactive Voice Response Service) Call is used for the user to pay for parking. In this case, the user parks his vehicle and notes down the bay id from the kerbside as above. The user then dials the IVRS number and initiates the transaction. The user then keys in the bay ID and selects a mode of payment. For registered users, if the phone being used to call the number is a registered one, no further input is required. However, the user is given a choice not to proceed with registered payment gateway and use the unregistered methods of payment if desired. The ePay system architecture is shown in FIG. 8.

For unregistered users, the user can key in credit card details and pre-loaded cash card details as above. Also, mobile account charging may be used where the user selects and confirms this option. Here, the amount will be charged to the mobile service provider of the phone which is being used to initiate the call. Also, the user selects either a time limit or a dollar amount and confirms the transaction so that payment can be made accordingly. The transaction is processed and the specific information (e.g. payment time, bay ID, paid amount) is transmitted to the data cloud (subject to approval of the payment) and a payment summary with expiry time of the transaction is being sent back to the user as a SMS. Again, a reminder SMS is sent to the user a few minutes before his parking time expires. If the parking limit of that specific zone allows for an extension, the user can purchase an extension of parking time by sending another SMS as a reply just specifying the extension time. The payment will be put through as the last mode of payment used and another payment summary with the expiry time of the transaction will be sent back to the user as a reply SMS.

In the “Park-and-leave” embodiment described above, a user registers with a parking resource provider using their registration plate number and enters into contract with the provider for automatic payment of parking. In this case, when a “Park and Leave” registered registration plate is recognised by the citation module, the software in the citation module will automatically discard that transaction and charge that particular transaction to a pre-arranged method of payment rather than issue a parking infringement notice, provided that the user has not contravened any other designated parking rules such as overstaying. Thus, in use, the user just needs to park his/her vehicle (the registration plate of which is already pre-registered to “Park-and-leave” database) in the “Park-and-leave” service area of parking bays and leave. The user will thus be charged accordingly. This will reduce the hassle of making on-spot payment (whether it's a manual payment or an electronic payment), and also allow the user to pay only for the time he/she has used for parking. The “Park and Leave” can be also applicable for unregistered users, where any usage is billed to the registered owner of the vehicle recognised by the citation module as described above (e.g. by fetching the owner details from a DMV database).

Referring back to FIG. 2, there is shown an automated vehicle parking management method 32. The method 32 includes the steps of acquiring 34 a series of images over time of at least one parking bay having a designated parking rule using at least one image acquisition means, detecting 36 presence of a vehicle parked in said at least one parking bay using at least one sensor; deriving 38 arrival and departure triggers for the vehicle parked in the at least one parking bay from information from the at least one sensor indicative of the presence of said vehicle parked in said at least one parking bay, acquiring 40 a buffer of said images of the at least one parking bay upon receipt of said arrival trigger and/or said departure trigger for the vehicle parked in the at least one parking bay, whereby the buffer extends for an allocated series of said images acquired immediately before the arrival trigger and/or the departure trigger to a further allocated series of said images acquired immediately after the arrival trigger and/or the departure trigger, respectively, and determining 42 whether the vehicle parked in said at least one parking bay contravenes the designated parking rule for that parking bay based on the arrival and the departure triggers, whereby a parking infringement notice can be issued to a registered owner of the vehicle based on a registration plate of the vehicle recognised from the buffer if the vehicle parked in the at least one parking bay has been determined as contravening the designated parking rule.

Further aspects of the method will be apparent from the above description of the system. Persons skilled in the art will also appreciate that the method can be embodied in program code. The program code could be supplied in a number of ways, for example on a tangible computer readable medium, such as a disc or a memory or as a data signal or data file.

It will be understood to persons skilled in the art of the invention that many modifications may be made without departing from the spirit and scope of the invention; in particular, it will be apparent that certain features of the embodiments of the invention can be employed to form further embodiments.

It is to be understood that, if any prior art is referred to herein, such reference does not constitute an admission that the prior art forms a part of the common general knowledge in the art in any country.

1. An automated vehicle parking management system, including
at least one image acquisition means configured to acquire a series of images over time of at least one parking bay having a designated parking rule;
at least one sensor configured to detect presence of a vehicle parked in said at least one parking bay;
a sensor module configured to derive arrival and departure triggers for the vehicle parked in the at least one parking bay from information from the at least one sensor indicative of the presence of said vehicle parked in said at least one parking bay;
an image acquisition module configured to acquire a buffer of said images of the at least one parking bay upon receipt of said arrival trigger and/or said departure trigger from the sensor module for the vehicle parked in the at least one parking bay, whereby the buffer extends for an allocated series of said images acquired immediately before the arrival trigger and/or the departure trigger to a further allocated series of said images acquired immediately after the arrival trigger and/or the departure trigger, respectively; and
a citation module configured to determine whether the vehicle parked in said at least one parking bay contravenes the designated parking rule based on the arrival and the departure triggers received from the sensor module, whereby a parking infringement notice can be issued to a registered owner of the vehicle based on a registration plate of the vehicle recognised from the buffer if the vehicle has been determined as contravening the designated parking rule.

2. A system as claimed in claim 1, wherein the sensor module derives the arrival and the departure triggers by periodically scanning the at least one sensor for a change in state of the at least one sensor indicating said presence of the vehicle parked in said at least one parking bay.

3. A system as claimed in claim 2, wherein the sensor module implements a clock and derives an arrival and a departure time for the vehicle parked in the at least one parking bay using the arrival and the departure triggers and the clock.

4. A system as claimed in claim 3, wherein the sensor module is further configured to record a log of the arrival and the departure times for the vehicle in the at least one parking bay in a database in data communication therewith.

5. A system as claimed in claim 4, wherein the designated parking rule is a designated time limit and the citation module determines whether the vehicle parked in said at least one parking bay contravenes the designated time limit using the arrival and the departure times recorded in the log.

6. A system as claimed in claim 4, wherein the designated parking rule is a paid parking time limit corresponding to an amount paid for parking said vehicle.

7. A system as claimed in claim 6, wherein the citation module determines whether the vehicle parked in said at least one parking bay contravenes the designated paid parking limit using the arrival and the departure times recorded in the log and the amount paid.

8. A system as claimed in claim 4, further including a payment module configured to determine an amount to be paid for parking said vehicle in the at least one parking bay using the arrival and the departure times recorded in the log.

9. A system as claimed in claim 8, further including a user database including details of a user parking said vehicle, whereby the payment module is further configured to issue said amount to be paid to the user based on the details in the database.

10. A system as claimed in claim 8, wherein the payment module is further configured to issue said amount to be paid to the registered owner of the vehicle based on the registration plate of the vehicle recognised from the buffer.

11. A system as claimed in claim 10, wherein the payment module is further configured to electronic payment of the amount to be paid for parking said vehicle.

12. A system as claimed in claim 1, wherein the image acquisition module is further configured to record a First In First Out buffer of said images of the at least one parking bay in a volatile physical memory in data communication therewith.

13. A system as claimed in claim 12, wherein the image acquisition module is further configured to acquire the buffer of said images of the at least one parking bay from the volatile physical memory upon receipt of the arrival and/or the departure trigger.

14. A system as claimed in claim 13, herein the image acquisition module is further configured to record the buffer of said images of the at least one parking bay showing the vehicle parked therein in a database in data communication therewith.

15. A system as claimed in claim 14, further including a registration plate recognition module configured to electronically recognise said registration plate of the vehicle from the buffer recorded in the database.

16. A system as claimed in claim 14, wherein the registration plate recognition module is further configured to scan predefined areas in the images of the at least one parking bay corresponding to a likely area of the registration plate of the vehicle.

17. An automated vehicle parking management method, including:
acquiring a series of images over time of at least one parking bay having a designated parking rule using at least one image acquisition means;
detecting presence of a vehicle parked in said at least one parking bay using at least one sensor;
deriving arrival and departure triggers for the vehicle parked in the at least one parking bay from information from the at least one sensor indicative of the presence of said vehicle parked in said at least one parking bay;
acquiring a buffer of said images of the at least one parking bay upon receipt of said arrival trigger and/or said departure trigger for the vehicle parked in the at least one parking bay, whereby the buffer extends for an allocated series of said images acquired immediately before the arrival trigger and/or the departure trigger to a further allocated series of said images acquired immediately after the arrival trigger and/or the departure trigger, respectively; and
determining whether the vehicle parked in said at least one parking bay contravenes the designated parking rule for that parking bay based on the arrival and the departure triggers, whereby a parking infringement notice can be issued to a registered owner of the vehicle based on a registration plate of the vehicle recognised from the buffer if the vehicle parked in the at least one parking bay has been determined as contravening the designated parking rule.

18. An automated vehicle parking management server, including
a sensor module configured to derive arrival and departure triggers for a vehicle parked in at least one parking bay having a designated parking rule from information from at least one sensor configured to detect presence of said vehicle parked in said at least one parking bay;
an image acquisition module configured to acquire a buffer of images from at least one image acquisition means configured to acquire a series of images over time of the at least one parking bay upon receipt of said arrival trigger and/or said departure trigger from the sensor module, whereby the buffer extends for an allocated series of said images acquired immediately before the arrival trigger and/or the departure trigger to a further allocated series of said images acquired immediately after the arrival trigger and/or the departure trigger, respectively; and
a citation module configured to determine whether the vehicle parked in said at least one parking bay contravenes the designated parking rule based on the arrival and the departure triggers received from the sensor module, whereby a parking infringement notice can be issued to a registered owner of the vehicle based on a registration plate of the vehicle recognised from the buffer if the vehicle has been determined as contravening the designated parking rule.

19-21. (canceled)
